(19) United States
(12) Patent Application Publication
(10) Pub. No.: US 2009/0173651 A1
(43) Pub. Date: Jul. 9, 2009

(54) Sheet metal pry hooks

(76) Inventor: Robert J. Griffis, San Pablo, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/003,920

(22) Filed: Jan. 3, 2008

(51) Int. Cl. B21D 1/06; B21D 1/12; B25F 1/00; B21D 1/00

(52) U.S. Cl. 206/372; 72/458; 254/131

(57) ABSTRACT

The sheet metal pry hooks are pry hooks having a hook end oriented in a manner to allow gripping and bending of an automotive sheet metal panel(s) in almost any situation encountered in the repair of such panel(s). As presently contemplated, the pry hooks will be made available either individually or as a kit of three pry hooks having different configurations of the hook, including at least one hook having the hook member offset from the longitudinal axis of the shank of the tool. The kit allows a user to have at hand a complete array of hooks needed for bending and orienting sheet metal panels in almost any repair situation.

### BACKGROUND OF THE INVENTION

1. Field of the Invention

The present invention generally relates to hand tools. More specifically, the present invention is drawn to sheet metal pry hooks used to align and orient automobile sheet metal panels.

2. Description of the Related Art

In the automotive body repair art, overbending and distorting the relatively thin, sheet metal body parts often necessitates the use of plastic fillers and the like to repair the damaged sheet metal. The use of such fillers often lessens the value of the automobile. The art would certainly welcome a set of tools that could efficiently bend and align the edges of relatively thin panels of sheet metal to prevent over-bending and distortion and eliminate the use of plastic fillers and the like. Thus, a kit of sheet metal pry hook tools solving the aforementioned problems is desired.

### SUMMARY OF THE INVENTION

The sheet metal pry hooks comprise a kit of sheet metal pry hook tools wherein each tool in the kit has a hook end oriented in a manner to allow gripping and bending of an automotive sheet metal panel in almost any situation encountered in the repair of such panels. As presently contemplated, the tools will be made available as a kit. This arrangement allows a user to have at hand a complete array of hooks needed for bending and orienting sheet metal panels in almost any repair situation.

Accordingly, the invention presents a kit of tools that are effective in facilitating bending, aligning and orienting sheet metal panels in a variety of applications. Each tool of the set incorporates a hook end of a configuration especially adapted to a specific bending, aligning or orienting task. The invention provides for an arrangement of improved elements for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a first sheet metal pry hook included in a kit of sheet metal pry hooks according to the present invention.

FIG. 2 is a perspective view of the sheet metal pry hook of FIG. 1.

FIG. 3 is an end view of the sheet metal pry hook of FIG. 1.

FIG. 4 is a perspective view of a second sheet metal pry hook included in a kit of sheet metal pry hooks according to-the present invention.

FIG. 5 is a perspective view of a third sheet metal pry hook included in a kit of sheet metal pry hooks according to the present invention.

FIG. 6 is a perspective view of a kit of sheet metal pry hooks according to the present invention.

Similar reference characters denote corresponding features consistently throughout the attached drawings.

### DETAILED DESCRIPTION OF THE PREFERRED EMBODIMENTS

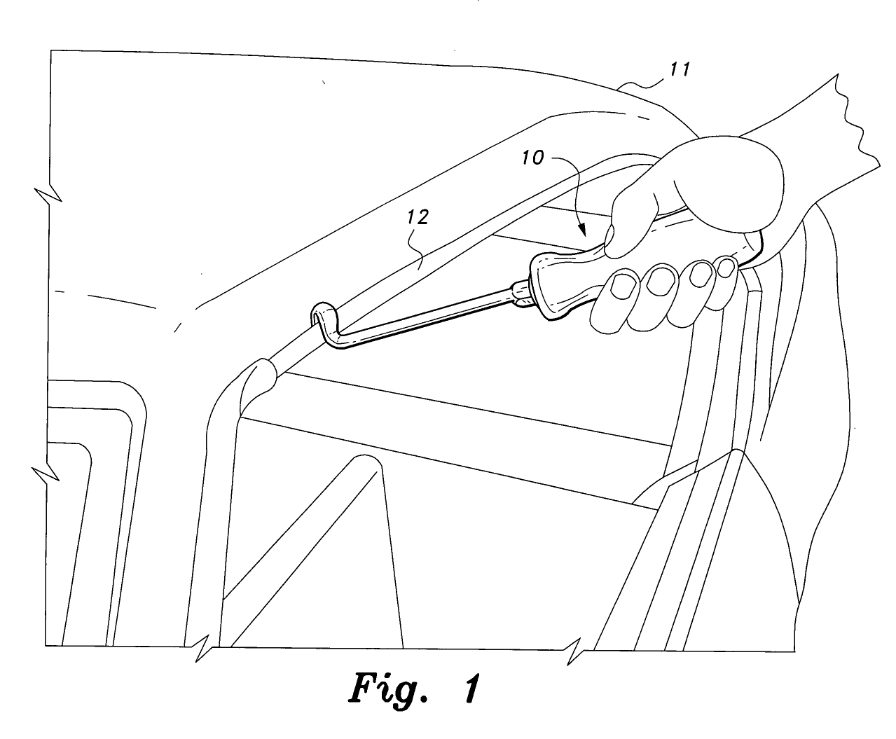

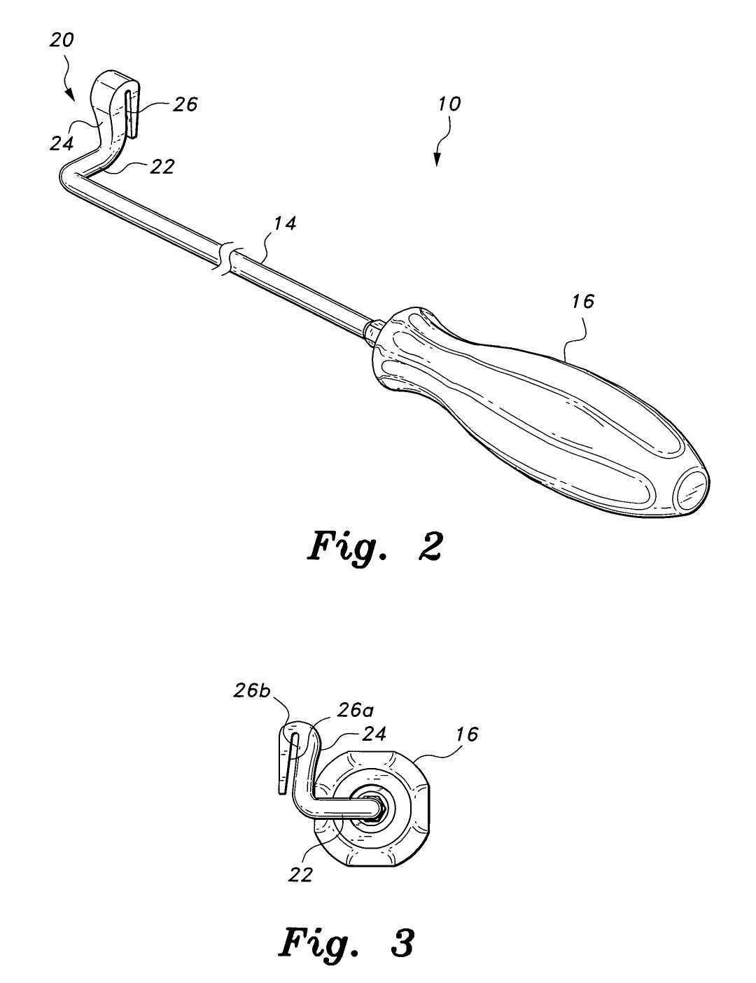

Attention is first directed to FIGS. 1-3 wherein a first sheet metal pry hook is generally indicated at 10. Sheet metal pry hook 10 is utilized to grasp, bend and align the edges 12 of a sheet metal panel on an automobile 11. As indicated above, tool 10 is effective in facilitating bending, aligning and orienting sheet metal panels in a variety of applications.

The pry hook 10 comprises a shank portion 14 having one end terminating in a handle 16. The other end of shank 14 is defined as a hook member 20. Hook member 20 includes a first bend portion 22 that is perpendicular to the longitudinal axis of shank 14. A second bend portion 24 extends perpendicular to a plane containing both the shank 14 and the first bend portion 22. The second bend portion 24 terminates in a U-shaped, open-ended slot 26. The slot 26 is formed with spaced, parallel, planar faces 26a, 26b. The planar face configuration permits grasping of a sheet metal edge without unduly marring the edge. Hook 20 is laterally offset from the longitudinal axis of shank 14. The pry hook 10 allows a user to grasp, bend, and orient sheet metal edges that would otherwise be difficult to access.

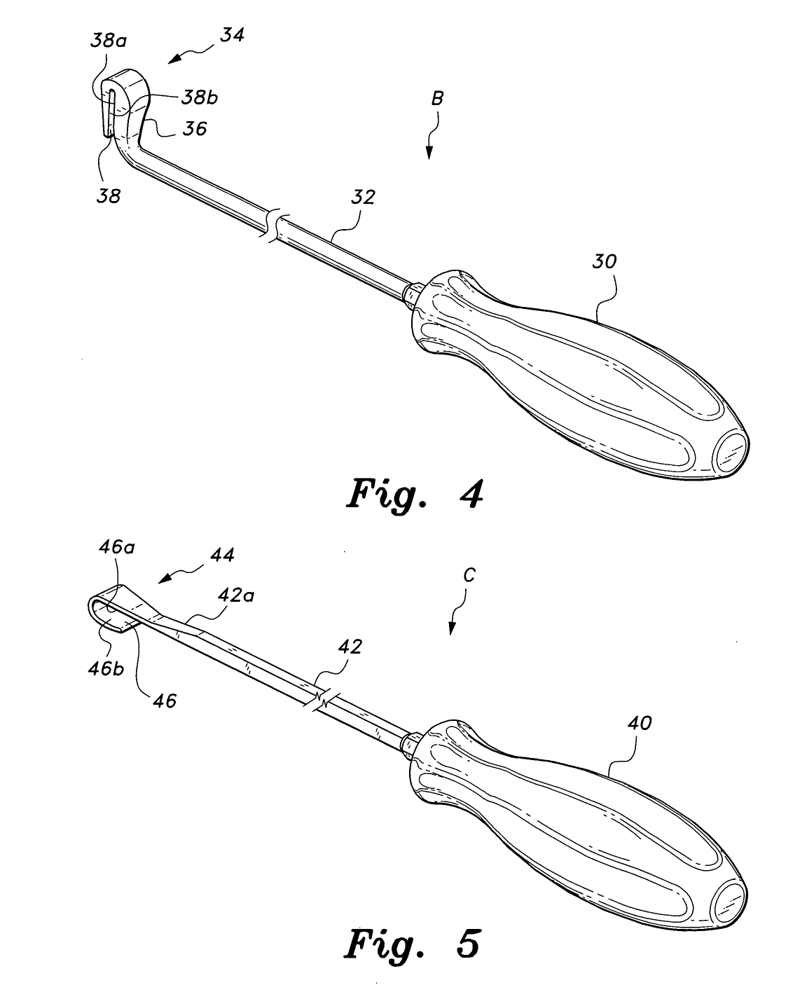

A second sheet metal pry hook, designated as B in FIG. 4, comprises a shank portion 32 having a handle 30 at one end and a hook member 34 at the other end. Hook member 34 includes a bend portion 36 that is perpendicular to the longitudinal axis of shank 32. Bend portion 36 terminates in a U-shaped, open-ended slot 38. Slot 38 is formed with spaced parallel, planar faces 38a, 38b. Slot 38 is normal to shank 32, but the open mouth of the slot is axially aligned with the shank 32.

FIG. 5 shows a third sheet metal pry hook C having a shank 42 of square or rectangular cross section. Handle 40 is disposed at one end of shank 42. The other end of the shank 42 is formed with a tapered portion 42a that terminates in a hook member 44. Hook member 44 is provided with a U-shaped, open ended slot 46 having spaced, parallel planar faces 46a, 46b. Slot 46 extends parallel to shank 42.

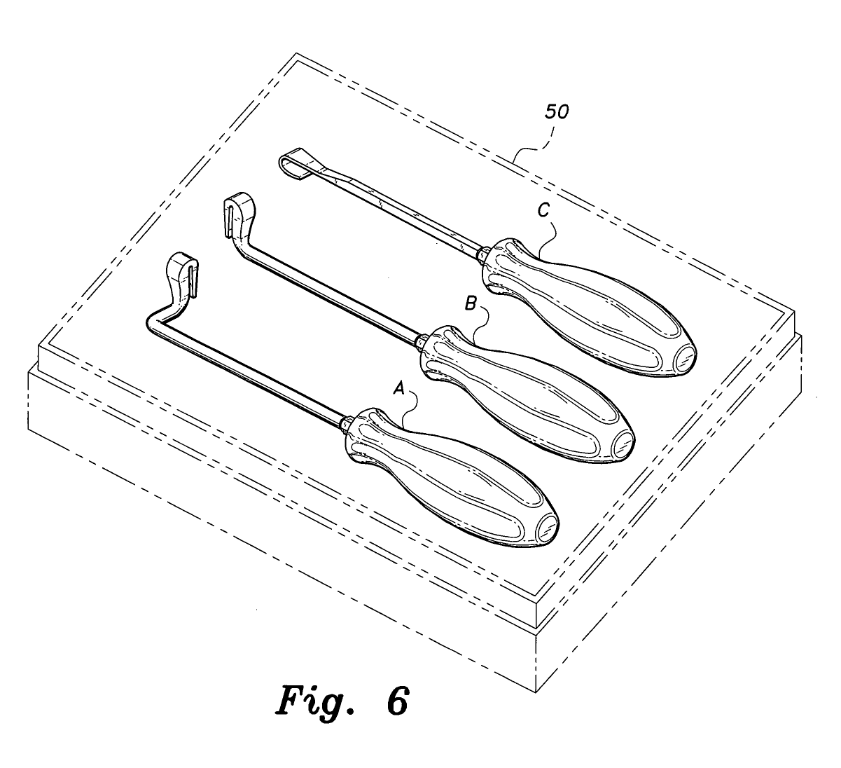

The configurations of pry hooks 10, B and C permit a user to access almost any automotive sheet metal panel edge arrangement, and allows the user to bend and align the same for repair. As shown in FIG. 6, the three pry hooks (with pry hook 10 being designated as pry hook A) may be available either individually or as a kit 50 for the convenience of the user.

It is to be understood that the present invention is not limited to the embodiments described above, but encompasses any and all embodiments within the scope of the following claims.

I claim:

1. A sheet metal pry hook tool, comprising:
a shank having a longitudinal axis, a first end and a second end;
a handle disposed at the first end of the shank;
a hook member defined at the second end of the shank, the hook member having a U-shaped, open-ended slot, the slot having spaced, parallel, planar faces.

2. The sheet metal pry hook tool according to claim 1, wherein said hook member includes a first bend portion perpendicular to the longitudinal axis of said shank.

3. The sheet metal pry hook tool according to claim 1, wherein said shank has a tapered portion adjacent said hook member.

4. The sheet metal pry hook tool according to claim 1, wherein said hook member includes a first bend portion extending from said shank perpendicular to the longitudinal axis of said shank, and a second bend portion extending from the first bend portion perpendicular to a plane defined by the longitudinal axis of said shank and the first bend portion.

5. A sheet metal pry hook tool, comprising:
a shank having a longitudinal axis, a first end and a second end;
a handle disposed at the first end of the shank; and
a hook member defined at the second end of the shank, the hook member having a first bend portion extending from the shank perpendicular to the longitudinal axis of the shank and a second bend portion extending from said first bend portion perpendicular to a plane defined by the shank and the first bend portion, the second bend portion terminating in a U-shaped, open-ended slot, the slot having spaced, parallel, planar faces.

6. A kit of sheet metal pry hooks, comprising a plurality of pry hooks, each of the pry hooks having:
a shank having a longitudinal axis, a first end and a second end;
a handle disposed at the first end of the shank; and
a hook member defined at the second end of the shank, the hook member having a U-shaped, open-ended slot and spaced, parallel, planar faces.

7. The kit according to claim 6, wherein said plurality of pry hooks comprises three sheet metal pry hooks having the hook members disposed in different configurations.

8. The kit according to claim 7, wherein:
the hook member of a first one of said three pry hooks has a bend portion perpendicular to the longitudinal axis of said shank;
the shank of a second one of said three pry hooks has a tapered portion adjacent the hook member; and
the hook member of a third one of said pry hooks has a first bend portion extending perpendicular to the longitudinal axis of said shank and a second bend portion extending the first bend portion perpendicular to a plane defined by the longitudinal axis of said shank and said first bend portion.
